(19) United States
(12) Patent Application Publication
(10) Pub. No.: US 2023/0170534 A1
(43) Pub. Date: Jun. 1, 2023

(54) SECONDARY BATTERY AND MANUFACTURING METHOD THEREFOR

(71) Applicant: NGK INSULATORS, LTD., Nagoya-City (JP)

(72) Inventors: Shinichiro SHICHI, Nagoya-City (JP); Kunihiko YOSHIOKA, Nagoya-City (JP)

(73) Assignee: NGK INSULATORS, LTD., Nagoya-City (JP)

(21) Appl. No.: 18/161,933

(22) Filed: Jan. 31, 2023

Related U.S. Application Data
(63) Continuation of application No. PCT/JP2021/032373, filed on Sep. 2, 2021.

(30) Foreign Application Priority Data
Sep. 4, 2020 (JP) 2020-149465

(51) Int. Cl. H01M 10/28; H01M 10/30; H01M 4/38; H01M 4/24; H01M 50/489; H01M 50/463; H01M 50/474; H01M 50/486; H01M 50/477; H01M 50/403; H01M 50/46

(52) U.S. Cl. CPC H01M 10/28; H01M 10/30; H01M 4/38; H01M 4/244; H01M 50/489; H01M 50/463; H01M 50/474; H01M 50/486; H01M 50/477; H01M 50/403; H01M 50/46; H01M 2004/027

(57) ABSTRACT

Provided is a secondary battery including a power generation unit including a positive electrode layer, a negative electrode layer, a porous separator, and an electrolytic solution. The negative electrode layer is a dissolution-deposition electrode. When viewed in plan view, a functional region, identified as a region where the positive electrode layer, the negative electrode layer, the electrolytic solution, and the porous separator overlap, is divided into power generation regions and a linear non-power generation region demarcating each power generation region. The power generation regions have a value α of 30 or less, the value α being defined by the equation: α=ΦP/wt, wherein Φ represents an area equivalent diameter (mm) per region of the power generation regions, P represents a thickness (mm) of the negative electrode layer, w represents a line width (mm) of the non-power generation region, and t represents a thickness (mm) of the porous separator.

### CROSS-REFERENCE TO RELATED APPLICATIONS

This application is a continuation application of PCT/JP2021/032373 filed Sep. 2, 2021, which claims priority to Japanese Patent Application No. 2020-149465 filed Sep. 4, 2020, the entire contents all of which are incorporated herein by reference.

### BACKGROUND OF THE INVENTION

### 1. Field of the Invention

The present invention relates to secondary batteries, particularly a secondary battery having a dissolution-deposition electrode whose electrode active material is repeatedly dissolved and deposited through charge-discharge, and a method for manufacturing the same.

### 2. Description of the Related Art

Zinc secondary batteries and other secondary batteries having a dissolution-deposition electrode whose electrode active material is repeatedly dissolved and deposited with charge-discharge have a known problem, negative electrode shape change problem, that the negative electrode gradually changes in shape and dimensions undesirably with repeated charge-discharge. In the case of zinc secondary batteries, for example, a phenomenon occurs, as depicted in FIG. 7, in which the negative electrode layer 14 becomes unevenly smaller from the end toward the center as the battery repeats charge-discharge, that is, the periphery of the negative electrode layer 14 is unevenly eroded and lost. This is caused by the negative electrode active material 14a (ZnO) making up the negative electrode layer 14 migrating from the end of the battery toward the center through repeated dissolution and deposition accompanying charge-discharge. In other words, the dissolution of ZnO causes zincate ions to diffuse, gradually deforming the negative electrode layer 14 toward the center. The shape change of the negative electrode layer 14 leads to a reduced effective region of the negative electrode layer 14 opposing the positive electrode layer 12, resulting in increased battery resistance, reduced battery capacity, and finally, reduced service life of the secondary battery.

Various zinc secondary batteries have been devised to address such a negative electrode shape change problem. For example, Patent Literature 1 (JP2019-106351A) discloses a zinc secondary battery including a positive electrode reaction-inhibiting structure that inhibits the electrochemical reaction at the end of the positive electrode active material layer, and/or a negative electrode reaction-inhibiting structure that inhibits the electrochemical reaction in the excess periphery region of the negative electrode active material layer. Patent Literature 2 (JP2020-38763A) discloses a zinc secondary battery in which the negative electrode contains a Zn compound that is a composite metal oxide of Zn and at least one selected from the group consisting of Al, In, Ti, and Nb. Patent Literature 3 (WO2020/049902) discloses a zinc secondary battery including a negative electrode containing: (A) ZnO particles; and (B) at least two selected from (i) metallic Zn particles with an average particle size D50 of 5 μm to 80 μm, (ii) one or more metal elements selected from In and Bi, and (iii) a binder resin having a hydroxy group.

### CITATION LIST

### Patent Literature

Patent Literature 1: JP2019-106351A
Patent Literature 2: JP2020-38763A
Patent Literature 3: WO2020/049902

### SUMMARY OF THE INVENTION

The approach of Patent Literature 1 requires that the positive electrode and/or the negative electrode are provided with an additional reaction inhibiting structure, accordingly complexing the manufacturing process and increasing the manufacturing cost. Also, the approach of Patent Literature 2 requires adding further constituents to the negative electrode, increasing the manufacturing cost. Accordingly, if the shape change of the negative electrode could be reduced by only applying simple processing using the existing positive electrode, negative electrode, and separator, such an approach is advantageous in terms of mass production and manufacturing cost.

The present inventors recently found that the shape change of the negative electrode can be reduced effectively at a low cost by simply demarcating a plurality of power generation regions by a linear non-power generation region so as to satisfy predetermined conditions.

Accordingly, it is an object of the present invention to provide a secondary battery that can reduce the shape change of the negative electrode accompanying repeated charge-discharge effectively at a low cost.

According to an aspect of the present invention, there is provided a secondary battery comprising a dissolution-deposition electrode whose electrode active material is repeatedly dissolved and deposited through charge-discharge, wherein the secondary battery comprises a power generation unit,
wherein the power generation unit comprises:
   a positive electrode layer including a positive electrode active material and a positive electrode current collector supporting the positive electrode active material;
   a negative electrode layer including a negative electrode active material and a negative electrode current collector supporting the negative electrode active material;
   a porous separator interposed between the positive electrode layer and the negative electrode layer; and
   an electrolytic solution with which the positive electrode layer, the negative electrode layer, and the porous separator are impregnated,
wherein the negative electrode layer is the dissolution-deposition electrode,
wherein when the power generation unit is viewed in plan view, a functional region, which is identified as a region where the positive electrode layer, the negative electrode layer, the electrolytic solution, and the porous separator overlap, is divided into a plurality of power generation regions and a linear non-power generation region demarcating each of the plurality of power generation regions, and
wherein the power generation regions have a value α of 30 or less, the value α being defined by the following equation:

α=ΦP/wt
wherein Φ represents an area equivalent diameter (mm) per region of the power generation regions, P represents a thickness (mm) of the negative electrode layer, w represents a line width (mm) of the non-power generation region, and t represents a thickness (mm) of the porous separator.

According to another aspect of the present invention, there is provided a method for manufacturing the secondary battery, the method comprising the steps of:
processing a porous separator to divide the porous separator into porous portions defining a plurality of power generation regions and a dense portion defining a linear non-power generation region demarcating each of the power generation regions; and
assembling the secondary battery using the divided porous separator, the positive electrode layer, the negative electrode layer, and the electrolytic solution.

### BRIEF DESCRIPTION OF THE DRAWINGS

FIG. 1 is a sectional view illustrating the conceptual structure of a secondary battery according to the present invention.

FIG. 2 is a sectional view of the secondary battery depicted in FIG. 1, taken along line A-A.

FIG. 3 is a conceptual representation illustrating a reduced shape change of the negative electrode in a secondary battery having an a value of 30 or less according to the present invention.

FIG. 4 is a conceptual representation illustrating a progressing shape change of the negative electrode in a secondary battery having an a value exceeding 30.

FIG. 5 is a conceptual sectional view illustrating an example of the secondary battery with a resin spacer according to the present invention.

FIG. 6 is a conceptual sectional view illustrating an example of the secondary battery with a negative electrode spacer according to the present invention.

FIG. 7 is a conceptual representation illustrating a progressing shape change of the negative electrode in a known secondary battery.

### DETAILED DESCRIPTION OF THE INVENTION

### Secondary Battery

The secondary battery according to the present invention has a dissolution-deposition electrode in which the electrode active material is repeatedly dissolved and deposited through charge-discharge. A typical dissolution-deposition electrode is the zinc negative electrode of zinc secondary batteries. Exemplary zinc secondary batteries include nickel-zinc secondary batteries, silver oxide-zinc secondary batteries, manganese oxide-zinc secondary batteries, and zinc-air secondary batteries. Accordingly, a zinc secondary battery will be described as appropriate in the following description.

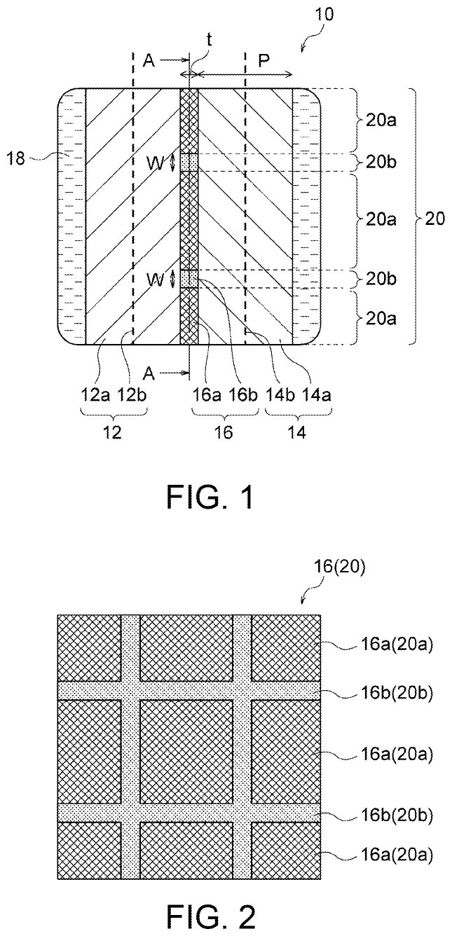

FIGS. 1 and 2 depict conceptional diagrams of such a secondary battery. The secondary battery includes a power generation unit 10. The power generation unit 10 includes a positive electrode layer 12, a negative electrode layer 14, a porous separator 16, and an electrolytic solution 18. The positive electrode layer 12 includes a positive electrode active material 12a and a positive electrode current collector 12b supporting the positive electrode active material. The negative electrode layer 14 includes a negative electrode active material 14a and a negative electrode current collector 14b supporting the negative electrode active material. The porous separator is interposed between the positive electrode layer 12 and the negative electrode layer 14. The positive electrode layer 12, the negative electrode layer 14, and the porous separator 16 are impregnated with the electrolytic solution 18. The negative electrode layer 14 is a dissolution-deposition electrode. This secondary battery is such that when the power generation unit 10 is viewed in plan view, a functional region 20, which is identified as a region where the positive electrode layer 12, the negative electrode layer 14, the electrolytic solution 18, and the porous separator 16 overlap, is divided into a plurality of power generation regions 20a and a linear non-power generation region 20b demarcating each of the plurality of power generation regions 20a. In FIGS. 1 and 2, the power generation regions 20a and the non-power generation region 20b are defined by porous portions 16a and a dense portion 16b of the porous separator 16, respectively. However, the power generation regions 20a and the non-power generation region 20b may be demarcated by masking or the like (for example, the non-power generation region 20b may be defined by filling the porous portions 16a with a paste).

The power generation regions 20a have a value α of 30 or less, the value α being defined by the following equation:

α=ΦP/wt

wherein Φ represents the area equivalent diameter (mm) per region of the power generation regions 20a, P represents the thickness (mm) of the negative electrode layer 14, w represents the line width (mm) of the non-power generation region 20b, and t represents the thickness (mm) of the porous separator 16. By simply demarcating the plurality of power generation regions 20a by the linear non-power generation region 20b so as to satisfy predetermined conditions in such a manner, the shape change of the negative electrode can be reduced effectively at a low cost. Reducing the shape change enables efficient use of the negative electrode active material 14a. Thus, the N/P ratio (ratio of the capacity of the negative electrode active material to the capacity of the positive electrode active material) can be reduced, making up a compact battery.

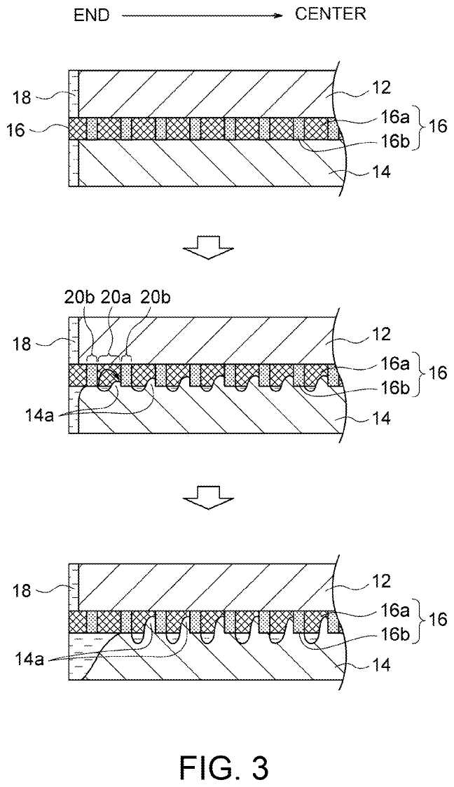

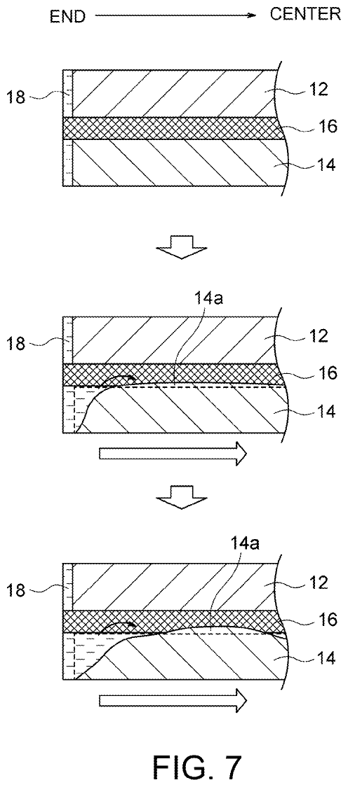

A possible mechanism by which when α is 30 or less, the shape change of the negative electrode is reduced will be described with reference to FIGS. 3 to 5. In the known zinc secondary batteries, a phenomenon occurs, as described above with reference to FIG. 7, the negative electrode layer 14 becomes unevenly smaller from the end toward the center as the battery repeats charge-discharge, that is, the periphery of the negative electrode layer 14 is unevenly eroded and lost. This is caused by the negative electrode active material 14a (e.g., ZnO) making up the negative electrode layer 14 migrating from the end of the electrode toward the center through repeated dissolution and deposition accompanying charge-discharge. In other words, the dissolution of ZnO causes zincate ions to diffuse, gradually deforming the negative electrode layer 14 toward the center. On the other hand, in the secondary battery of the present invention, a plurality of power generation regions 20a are demarcated by a linear non-power generation region 20b, as depicted in FIG. 3. As a result, the power generation regions 20a are deformed while the negative electrode active material 14a is repeatedly dissolved and deposited through charge-discharge cycles, whereas in the non-power generation region 20b, which is not at all or hardly involved in the charge-discharge, the dissolution and deposition of the negative electrode active material 14a accompanying charge-discharge are significantly reduced. Consequently, the negative electrode active material 14a, which is to be deposited in each power generation region 20a through charge-discharge, thus causing a shape change, is probably dammed at the non-power generation region 20b. It is considered that this can be achieved when the resistance of the non-power generation region 20b to the shape change surpasses the power of the shape change produced in the power generation regions 20a (specifically, by the negative electrode active material 14a being deposited in the power generation regions while deforming the power generation regions). Factors contributing to the shape change power produced in the power generation regions 20a include the area equivalent diameter Φ per region of the power generation regions 20a and the thickness P of the negative electrode layer 14. These factors affect the effective amount of the negative electrode active material 14a involved in the charge-discharge in the power generation regions 20a. On the other hand, factors contributing to the resistance of the non-power generation region 20b to the shape change include the line width w of the non-power generation region 20b and the thickness t of the porous separator 16. Hence, the fact that α=(ΦP/wt) is 30 or less can be expressed as ΦP/wt≤30, that is, ΦP≤30 wt. This relationship suggests that the right side (30 wt) reflecting the resistance to the shape change surpasses the left side (ΦP) reflecting the shape change power, leading to reduced shape change.

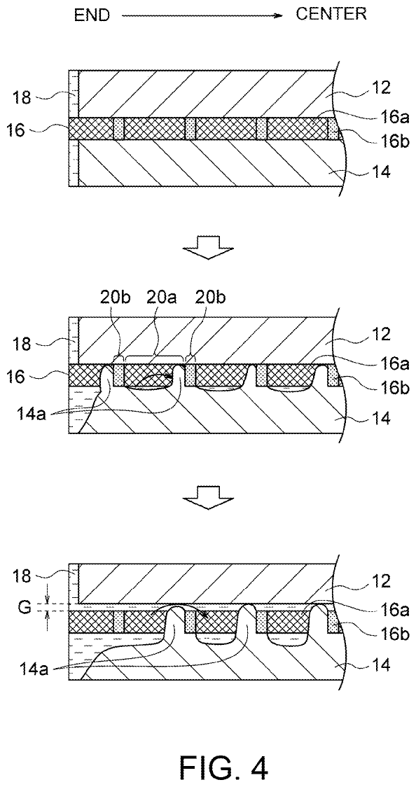

On the other hand, when α exceeds 30 (that is, ΦP>30 wt), the effect of reducing the shape change is inferior. For example, when the power generation regions 20a have relatively large areas, as depicted in FIG. 4, the area equivalent diameter Φ per region of the power generation regions 20a increases relatively. Accordingly, the left side (ΦP) reflecting the power of the shape change will surpass the right side (30 wt) reflecting the resistance to the shape change. As a result, the non-power generation region 20b cannot dam a large amount of negative electrode active material 14a deposited in the individual power generation regions 20a through charge-discharge, causing the shape change of the negative electrode layer 14 to progress inward from the end of the electrode, as depicted in FIG. 4. Probably, this forms a gap G between the positive electrode layer 12 and the porous separator 16, and the electrolytic solution 18 flows into the gap, accelerating the shape change. In this regard, when the value α is 30 or less, such a problem can be avoided, and consequently, the shape change of the negative electrode can be reduced effectively. In this instance, the amount of negative electrode active material 14a per region of the power generation regions 20a is relatively small, and the non-power generation region 20b can sufficiently exhibit the effect of damming the negative electrode active material, as depicted in FIG. 3.

From the viewpoint of such an effect, the value α is 30 or less and is preferably 28 or less, more preferably 26 or less, and still more preferably 24 or less. The lower limit of the value α is not particularly limited but is typically 5 or more, more typically 10 or more.

The area equivalent diameter Φ per region of the power generation regions 20a is preferably 6.0 mm or less, more preferably 5.0 mm or less, still more preferably 4.0 mm or less, particularly preferably 3.0 mm or less, and most preferably 2.0 mm or less. The area equivalent diameter is defined as the diameter of a circle with an area equal to the projected area per region of the power generation regions 20a, following the definition in JIS Z8827-1. The thickness P of the negative electrode layer 14 is preferably 0.1 mm to 1.0 mm, more preferably 0.2 mm to 0.9 mm, still more preferably 0.3 mm to 0.8 mm, and particularly preferably 0.4 mm to 0.7 mm. The line width W of the non-power generation region 20b is preferably 0.01 mm to 1.0 mm, more preferably 0.1 mm to 0.9 mm, still more preferably 0.2 mm to 0.8 mm, and particularly preferably 0.3 mm to 0.7 mm. The thickness t of the porous separator 16 is preferably 0.02 mm to 0.5 mm, more preferably 0.03 mm to 0.4 mm, still more preferably 0.04 mm to 0.3 mm, and particularly preferably 0.05 mm to 0.2 mm. The thickness of the porous separator 16 may be different between the porous portions 16a and the dense portion 16b. In such a case, the thickness of the thicker portions (typically, the porous portions 16a) can be used as the thickness t of the porous separator 16.

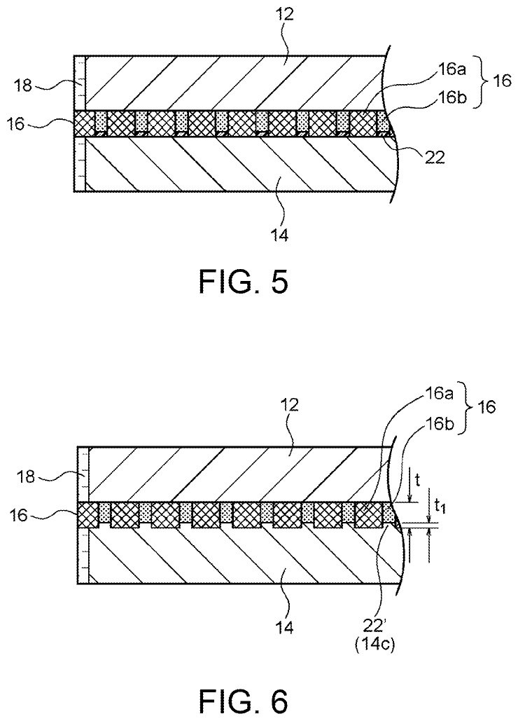

However, when the dense portion 16b is thinner than the porous portions 16a, the thinner dense portion 16b may be provided with a spacer (e.g., a resin spacer or a negative electrode spacer) so as to have the same thickness as the porous portions 16a, that is, so that the porous separator 16 can have a uniform thickness throughout. In other words, it is preferable to form a spacer 22 or 22′ to fill the gap(s) between the negative electrode layer 14 and the dense portion 16b, as depicted in FIGS. 5 and 6.

The spacer 22 according to the preferred embodiment depicted in FIG. 5 contains a resin. In other words, the gap(s) between the negative electrode layer 14 and the dense portion 16b can be filled by providing the resin spacer 22 at the positions corresponding to the dense portion 16b. Thus, the diffusion of zincate ions can be reduced more effectively than in the case without the spacer 22, and a more excellent effect of reducing the shape change can be produced.

The spacer 22′ according to another preferred embodiment depicted in FIG. 6 includes the negative electrode active material and/or the negative electrode current collector, thus forming protrusions 14c (hereinafter also referred to as the negative electrode spacer 22′) from the negative electrode layer 14. In other words, the gap between the negative electrode layer 14 and the dense portion 16b can be filled by forming the protrusions 14c containing the negative electrode active material and/or the negative electrode current collector at the surface of the negative electrode layer 14 in the position corresponding to the dense portion 16b. In this instance, preferably, the thickness t₁ (mm) of the protrusions 14c (namely, negative electrode spacer 22′) and the thickness t (mm) of the porous separator satisfy the relationship t₁/t≤0.5, from the viewpoint of reducing the diffusion of zincate ions more effectively and thus producing a more excellent effect of reducing the shape change.

Preferably, the power generation regions 20a and the non-power generation region 20b form a regular pattern. The regular pattern can evenly assign the power generation regions 20a throughout the functional region 20, thus reducing the shape change of the negative electrode effectively. In a preferred regular pattern, the shape of each power generation region 20a may be, for example, square, rectangular, lozenged, triangular, more polygonal, circular, and so forth, and is preferably square or lozenged.

The porous separator 16 may be a separator generally used in various secondary batteries. A preferred porous separator 16 is made of a porous film and/or a nonwoven fabric. The porous film and the nonwoven fabric are preferably made of resin from the viewpoint of allowing efficient formation of the dense portion by heat press. It should be noted that the LDH separator for preventing zinc dendrite from penetrating the zinc secondary battery, as disclosed in Patent Literatures 1 to 3, is a dense separator whose porous substrate is filled with a layered double oxide (LDH), and that is therefore distinguished from the porous separator. However, when a zinc secondary battery is used as the secondary battery, it is desirable to use an LDH separator in combination. In this instance, a preferred arrangement is in this order: positive electrode layer 12/LDH separator/porous separator 16/negative electrode layer 14.

Preferably, the porous separator 16 is divided into porous portions 16a and dense portion 16b. The porous portions 16a define the power generation regions 20a, and the dense portion 16b define the non-power generation region 20b. In other words, it is preferable to form the dense portion 16b in the porous separator 16 so that the denseness of the dense portion provides the non-power generation region 20b. More specifically, the dense portion 16b cancel the function of the porous separator 16 due to the denseness of the dense portion and is therefore not at all or hardly involved in the charge-discharge, consequently providing the non-power generation region 20b. This embodiment does not require additional special members to form the non-power generation region 20b and enables only the porous separator 16 divided into the porous portions 16a and the dense portion 16b to reduce the shape change of the negative electrode. This is advantageous not only in producing the effect of reducing the shape change at a low cost, but also in avoiding a decreased energy density of the battery resulting from the increase of the number of members and accompanying increase of the volume. The density of the dense portion 16b is 1.1 times or more the density of the porous portions 16a, preferably 1.3 times or more, more preferably 1.5 times or more, still more preferably 1.8 times or more, and particularly preferably 2.0 times or more. The higher the density of the dense portion 16b, the better, and the upper limit is not particularly limited.

The positive electrode layer 12 includes a positive electrode active material 12a and a positive electrode current collector 12b supporting the positive electrode active material. The materials of the positive electrode active material 12a and the positive electrode current collector 12b can be appropriately selected according to the type of secondary battery. In a nickel-zinc secondary battery, for example, the positive electrode active material 12a is preferably nickel hydroxide and/or nickel oxyhydroxide, and the positive electrode current collector 12b is preferably a porous nickel substrate, such as a nickel foam plate.

The negative electrode layer 14 includes a negative electrode active material 14a and a negative electrode current collector 14b supporting the negative electrode active material. The materials of the negative electrode active material 14a and the negative electrode current collector 14b can be appropriately selected according to the type of secondary battery. In a zinc secondary battery, the negative electrode active material 14a preferably contains a zinc material. The zinc material may be contained in any of the forms of zinc metal, a zinc compound, and a zinc alloy provided that the material has electrochemical activity suitable for the negative electrode. Preferred examples of the zinc material include zinc oxide, zinc metal, and calcium zincate. A mixture of zinc metal and zinc oxide is more preferred.

An electrolytic solution suitable for the secondary battery can be used as the electrolytic solution 18. For a zinc secondary battery, the electrolytic solution 18 preferably contains a solution of an alkali metal hydroxide. Examples of the alkali metal hydroxide include potassium hydroxide, sodium hydroxide, lithium hydroxide, and ammonium hydroxide, and potassium hydroxide is more preferred. Zinc oxide, zinc hydroxide, or the like may be added to the electrolytic solution to reduce the self-dissolution of the zinc-containing material.

### Method for Manufacturing the Secondary Battery

The secondary battery according to the present invention can be manufactured by (i) processing the porous separator 16 to divide the porous separator into porous portions 16a and dense portion 16b; and (ii) assembling the secondary battery using the divided porous separator 16, the positive electrode layer 12, the negative electrode layer 14, and the electrolytic solution 18.

### (i) Processing of Porous Separator

The porous separator 16 is processed to be divided into porous portions 16a defining a plurality of power generation regions 20a and a dense portion 16b defining the linear non-power generation region 20b demarcating each of the power generation regions 20a. The processing of the porous separator 16 may be performed without particular limitation provided that a predetermined density (e.g., 1.1 times or more the density of the porous portions 16a) can be given to the dense portion 16b. Preferably, however, the processing is performed by debossing the porous separator 16 to form the dense portion 16b because debossing is superior in low cost and mass production. Debossing is performed by pressing a die with a predetermined pattern (letterpress plate) on the porous separator 16 for compression, thus enabling simple, efficient formation of the dense portion 16b. The die (letterpress plate) preferably has a regular pattern as mentioned above. Also, when the die (letterpress plate) is pressed, heat is preferably applied. Such heat application can further increase the density of the dense portion 16b. In this viewpoint, the porous separator 16 is preferably made of resin.

### (ii) Assembling of Secondary Battery

The secondary battery is assembled using the porous separator 16 divided in the above-described manner, the positive electrode layer 12, the negative electrode layer 14, and the electrolytic solution 18. This assembling can be performed by a known manner without particular limitation.

(iii) Formation of Spacer

As mentioned above, a spacer may be formed on the surface of the negative electrode layer 14 and/or the surface of the dense portion 16b so as to fill the gap between the negative electrode layer 14 and the dense portion 16b after assembling the secondary battery. The spacer may be formed in any manner without particular limitation. For forming a resin spacer 22 as depicted in FIG. 5, a resin paste may be printed on the porous separator 16 divided in the above-described step (i) or on the negative electrode layer 14 before the above-described step (ii), thereby favorably forming the resin spacer 22. Examples of preferred printing methods include screen printing and gravure printing. For forming a negative electrode spacer 22′ as depicted in FIG. 6, the negative electrode layer 14 may be embossed or subjected to similar operation before the above-described step (ii) to form unevenness in the surface of the negative electrode layer, thereby favorably forming the negative electrode spacer 22′.

Thus, the manufacturing method of the present invention can reduce the shape change of the negative electrode effectively only by applying simple processing (e.g., debossing) to the porous separator 16, thus being extremely advantageous in terms of mass production and manufacturing cost.

### EXAMPLES

The present invention will further be described in detail with reference to the following Examples.

### Example 1 (Comparative)

### (1) Preparation of Nickel-Zinc Secondary Battery

A positive electrode layer, a negative electrode layer, a porous separator, and an electrolytic solution having the respective specifications presented below were prepared.
Positive electrode layer: Nickel foam (positive electrode current collector) whose pores are filled with a positive electrode active material slurry containing nickel hydroxide particles (size: 200 mm square, thickness: 0.5 mm)
Negative electrode layer: Negative electrode active material paste containing metallic zinc powder and zinc oxide powder pressed onto copper-expanded metal (negative electrode current collector) (size: 200 mm square, thickness: 0.5 mm (including the thickness of the negative electrode current collector))
Porous separator: Polypropylene nonwoven fabric (thickness: 100 μm, basis weight: 40 g/m²)
Electrolytic solution: 5.4 mol/L KOH aqueous solution in which 0.4 mol/L ZnO is dissolved

The negative electrode layer was wrapped in the porous separator and housed in a battery container, opposing the positive electrode layer. The electrolytic solution was introduced into the battery container to yield a nickel-zinc secondary battery.

### (2) Charge-Discharge Cycle Test

The resulting nickel-zinc secondary battery was subjected to a charge-discharge cycle test. The test was performed by repeating charge-discharge cycles 100 times under the following conditions:
Charge: voltage: 1.9 V, end capacity: 70%
Discharge: end capacity: 0%

The negative electrode layer was viewed in plan view before and after the cycle test, and the percentage (%) of the area S₁ covered with the negative electrode active material remaining after the 100-cycle test relative to the area S₀ covered with the negative electrode active material before the cycle test (that is, 100×S₁/S₀) was calculated to obtain the percentage (%) of the remaining area of the negative electrode layer. The resulting percentage (%) of the remaining area of the negative electrode layer was applied to the following criteria to rate the effect of reducing the shape change in three levels according:

Rating A: The remaining area percentage of the negative electrode layer was 70% or more.

Rating B: The remaining area percentage of the negative electrode layer was 60% to less than 70%.

Rating C: The remaining area percentage of the negative electrode layer was less than 60%.

### Examples 2 to 10

Nickel-zinc secondary batteries were produced and evaluated in the same manner as in Example 1, except that the porous separator was debossed into a regular pattern with the shape and the dimensions presented in Table 1 to form a dense portion so as to demarcate a plurality of porous portions, and that the porous separator and the negative electrode layer had the thicknesses as presented in Table 1. The debossing was performed by pressing a die (letterpress plate) with a regular pattern on the porous separator before being combined with the negative electrode layer and compressing the region that was to be dense portion (corresponding to the non-power generation region) with heating.

### Examples 11 to 13

Nickel-zinc secondary batteries were produced and evaluated in the same manner as in Examples 2 to 4, except that a resin spacer was formed, and that the porous separator and the negative electrode layer had the thicknesses as presented in Table 2. For forming the resin spacer, a resin paste was screen-printed on the surfaces of the dense portion of the porous separator.

### Examples 14 to 19

Nickel-zinc secondary batteries were produced and evaluated in the same manner as in Examples 2 to 4, except that a negative electrode spacer (negative electrode protrusions) was formed at the t₁/t ratio presented in Table 2, and that the porous separator and the negative electrode layer had the thicknesses as presented in Table 2. For forming the negative electrode spacer, the surface of the negative electrode layer was debossed to form negative electrode protrusions with a predetermined t₁/t ratio in the portion that was to face the dense portion so that the gap between the negative electrode layer and the dense portion would be filled after assembling.

### Results

The following Tables present the specifications and cycle test results of the batteries produced in Examples 1 to 19.

TABLE 1

| | Ex. 1* | Ex. 2 | Ex. 3* | Ex. 4 | Ex. 5 | Ex. 6* | Ex. 7* | Ex. 8 | Ex. 9* | Ex. 10* |
|---|---|---|---|---|---|---|---|---|---|---|
| Presence/absence of non-power | None | Present | | | Present | | | Present | | |
| generation region | | | | | | | | | | |
| Pattern of power generation regions | — | Pattern 1 (lozenge) | | | Pattern 2 (square) | | | Pattern 3 (square) | | |
| Side length L (mm) per region of Power | — | 1.8 | | | 3.0 | | | 5.4 | | |
| generation regions (porous portions) | | | | | | | | | | |
| Line width w (mm) of non-power | — | 0.6 | | | 0.5 | | | 0.8 | | |
| generation region (dense portion) | | | | | | | | | | |
| Area equivalent diameter Φ (mm) per | — | 2.0 | | | 3.4 | | | 6.1 | | |
| region of power generation regions | | | | | | | | | | |
| (porous portions) | | | | | | | | | | |
| Thickness t (mm) of porous separator | 0.1 | 0.05 | 0.05 | 0.1 | 0.05 | 0.05 | 0.1 | 0.05 | 0.05 | 0.1 |
| Area percentage (%) of dense portion in | 0 | 44 | | | 27 | | | 24 | | |
| porous separator | | | | | | | | | | |
| Ratio of dense portion density to porous | — | 2 | | | 2 | | | 2 | | |
| portion density in porous separator | | | | | | | | | | |
| Thickness P (mm) of negative electrode | 0.5 | 0.2 | 0.5 | 0.7 | 0.2 | 0.5 | 0.7 | 0.2 | 0.5 | 0.7 |
| layer | | | | | | | | | | |
| Spacer | None | None | | | None | | | None | | |
| α = ΦP/wt | — | 14 | 34 | 24 | 27 | 68 | 47 | 30 | 76 | 53 |
| Remaining area percentage (%) of | 67 | 84 | 69 | 76 | 73 | 49 | 53 | 71 | 51 | 57 |
| negative electrode layer after | | | | | | | | | | |
| completion of 100 cycles | | | | | | | | | | |
| Effect of reducing shape change | B | A | B | A | A | C | C | A | C | C |

*represents Comparative Example.

TABLE 2

| | Ex. 11 | Ex. 12 | Ex. 13 | Ex. 14 | Ex. 15 | Ex. 16 | Ex. 17 | Ex. 18 | Ex. 19 |
|---|---|---|---|---|---|---|---|---|---|
| Presence/absence of non-power generation | Present | | | Present | | | Present | | |
| region | | | | | | | | | |
| Pattern of power generation regions | Pattern 1 (lozenge) | | | Pattern 1 (lozenge) | | | Pattern 1 (lozenge) | | |
| Side length L (mm) per region of Power | 1.8 | | | 1.8 | | | 1.8 | | |
| generation regions (porous portions) | | | | | | | | | |
| Line width w (mm) of non-power generation | 0.6 | | | 0.6 | | | 0.6 | | |
| region (dense portion) | | | | | | | | | |
| Area equivalent diameter Φ (mm) per region | 2.0 | | | 2.0 | | | 2.0 | | |
| of power generation regions (porous | | | | | | | | | |
| portions) | | | | | | | | | |
| Thickness t (mm) of porous separator | 0.05 | 0.05 | 0.1 | 0.1 | 0.1 | 0.1 | 0.1 | 0.1 | 0.1 |
| Area percentage (%) of dense portion in | 44 | | | 44 | | | 44 | | |
| porous separator | | | | | | | | | |
| Ratio of dense portion density to porous | 2 | | | 2 | | | 2 | | |
| portion density in porous separator | | | | | | | | | |
| Thickness P (mm) of negative electrode | 0.2 | 0.5 | 0.7 | 0.2 | 0.5 | 0.7 | 0.2 | 0.5 | 0.7 |
| layer | | | | | | | | | |
| Spacer | Resin spacer | | | Negative electrode spacer | | | Negative electrode spacer | | |
| | | | | (t₁/t = 0.5) | | | (t₁/t = 0.8) | | |
| α = ΦP/wt | 14 | 34 | 24 | 14 | 34 | 24 | 14 | 34 | 24 |
| Remaining area percentage (%) of negative | 91 | 74 | 85 | 87 | 72 | 82 | 79 | 65 | 73 |
| electrode layer after completion of 100 | | | | | | | | | |
| cycles | | | | | | | | | |
| Effect of reducing shape change | A | A | A | A | A | A | A | B | A |

As suggested by the results presented in Table 1, Examples 2, 4, 5, and 8, in which the functional region was divided into a plurality of power generation regions and a linear non-power generation region demarcating each of the power generation regions and the value of parameter a was 30 or less, exhibited high remaining area percentages of the respective negative electrode layers after the completion of 100 cycles (that is, small shape change of the negative electrode) and thus increased cycle life, compared to Example 1, which was not provided with a non-power generation region, and Examples 3, 6, 7, 9, and 10, which had the non-power generation region but an a value of more than 30.

What is claimed is:

1. A secondary battery comprising a dissolution-deposition electrode whose electrode active material is repeatedly dissolved and deposited through charge-discharge, wherein the secondary battery comprises a power generation unit,
wherein the power generation unit comprises:
a positive electrode layer including a positive electrode active material and a positive electrode current collector supporting the positive electrode active material;
a negative electrode layer including a negative electrode active material and a negative electrode current collector supporting the negative electrode active material;
a porous separator interposed between the positive electrode layer and the negative electrode layer; and
an electrolytic solution with which the positive electrode layer, the negative electrode layer, and the porous separator are impregnated,
wherein the negative electrode layer is the dissolution-deposition electrode,
wherein when the power generation unit is viewed in plan view, a functional region, which is identified as a region where the positive electrode layer, the negative electrode layer, the electrolytic solution, and the porous separator overlap, is divided into a plurality of power generation regions and a linear non-power generation region demarcating each of the plurality of power generation regions, and
wherein the power generation regions have a value α of 30 or less, the value α being defined by the following equation:
α=ΦP/wt
wherein Φ represents an area equivalent diameter (mm) per region of the power generation regions, P represents a thickness (mm) of the negative electrode layer, w represents a line width (mm) of the non-power generation region, and t represents a thickness (mm) of the porous separator.

2. The secondary battery according to claim 1, wherein the value α is 24 or less.

3. The secondary battery according to claim 1, wherein the porous separator is divided into porous portions and a dense portion having a density 1.1 times or more the density of the porous portions, wherein the porous portions define the power generation regions, and the dense portion define the non-power generation region.

4. The secondary battery according to claim 1, wherein the power generation regions and the non-power generation region form a regular pattern.

5. The secondary battery according to claim 1, wherein the area equivalent diameter per region of the power generation regions is 3.0 mm or less.

6. The secondary battery according to claim 1, wherein the line width w of the non-power generation region is 0.01 mm to 1.0 mm.

7. The secondary battery according to claim 1, wherein the separator is a porous film and/or a nonwoven fabric.

8. The secondary battery according to claim 1, wherein the negative electrode active material contains a zinc material.

9. The secondary battery according to claim 3, wherein a spacer is provided between the negative electrode layer and the dense portion so as to fill a gap therebetween.

10. The secondary battery according to claim 9, wherein the spacer contains a resin.

11. The secondary battery according to claim 9, wherein the spacer includes the negative electrode active material and/or the negative electrode current collector, thereby forming a protrusion.

12. The secondary battery according to claim 11, wherein a thickness t₁ (mm) of the protrusion and the thickness t (mm) of the porous separator satisfy the following relationship:
t₁/t≤0.5.

13. A method for manufacturing the secondary battery according to claim 1, the method comprising:
processing a porous separator to divide the porous separator into porous portions defining a plurality of power generation regions and a dense portion defining a linear non-power generation region demarcating each of the power generation regions; and
assembling the secondary battery using the divided porous separator, the positive electrode layer, the negative electrode layer, and the electrolytic solution.

14. The method for manufacturing the secondary battery according to claim 13, wherein the processing of the porous separator is performed by debossing the porous separator to form the dense portion.

15. The method for manufacturing the secondary battery according to claim 13, further comprising forming a spacer on a surface of the negative electrode layer and/or a surface of the dense portion so that the spacer can fill a gap between the negative electrode layer and the dense portion after the assembling of the secondary battery.
